(19) United States
(12) Patent Application Publication
(10) Pub. No.: US 2005/0220101 A1
(43) Pub. Date: Oct. 6, 2005

(54) Method of performing charging and rewarding processes in ad hoc networks

(75) Inventors: Dirk Westhoff, Heidelberg (DE); Bernd Lamparter, Heidelberg (DE); Joao Girao, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/094,395

(22) Filed: Mar. 31, 2005

(30) Foreign Application Priority Data
Mar. 31, 2004 (DE) 10 2004 016 581.5

(51) Int. Cl. H04L 12/56

(52) U.S. Cl. 370/389

(57) ABSTRACT

A method of performing charging and rewarding processes in ad hoc networks with the ad hoc network showing a multitude of active nodes and with one node, which sends or receives packets, is charged costs and a node, which forwards packets within the ad hoc network, is rewarded, is characterized in that charging and rewarding data generated within the ad hoc network is transmitted via an access router to a component of the AAA (authentification, authorization, accounting) architecture for subsequent transmission and/or processing purposes.

### BACKGROUND OF THE INVENTION

1. Field of the Invention

The present invention relates to a method of performing charging and rewarding processes in ad hoc networks with the ad hoc network showing a multitude of active nodes, wherein a node, which is sending or receiving packets, is charged costs and a node, which forwards packets within the ad hoc network, is rewarded money.

2. Description of the Related Art

From the technical point of view, these civilian ad hoc networks are at the border to reality. But they will only be realistic and implementable in practice, if two essential conditions are met. First, the individual nodes of the ad hoc network must participate actively in the network, which is to say they must not only send and/or receive their own data, but they have to forward in particular foreign data. Second, the ad hoc networks must be designed in such a way that an ISP (Internet Service Provider) will not regard them as mere zero charged competitors in contrast to their traditional profitable networks, but as an independent profitable business model. Both aforementioned conditions cannot be assumed by nature. In particular, the first topic becomes critical if battery driven handhelds are assumed. The second topic is a critical one as up to now, for civilian ad hoc networks, no charging protocols have been used.

With a new family of volume based charging and rewarding protocols over wireless multihop ad hoc networks the situation has changed dramatically. Examples are approaches such as Sprite, SICP (Secure Incentive-based Charging Protocols) and Nuglet. The key idea of these approaches is to reward those nodes that forward the foreign data within the ad hoc network, i.e. which act as an intermediate node, because such a node spent battery power on forwarding foreign data.

The term of rewarding is meant in an abstract way and may be realized in a point system, a credit or a direct monetary reward, for example. On the other side, the node acting as sender or as addressee will be charged the costs by the ISP.

A problem in this context is the fact that you can generate data which is relevant for processes of charging and rewarding with already established methods and that you can transport it within the ad hoc network, but that an extensive usage of these data, by an ISP, for instance, is not yet possible.

### SUMMARY OF THE INVENTION

An object of the present invention is to provide a method of performing charging and rewarding processes in ad hoc networks of the aforementioned kind, in which the data related to charging and rewarding, is provided over the ad hoc network and hence extensively usable.

According to the present invention, the aforementioned problem is solved by the characteristics of claim 1. According to the present invention, the method is designed in such a way that charging and rewarding data, which is generated within an ad hoc network, is transmitted via an access router to one component of an AAA (authentification, authorization, accounting) architecture for further transmitting and/or processing purposes.

According to the invention, it has been recognized that it is necessary for an extensive usage of charging and rewarding concepts within ad hoc networks to connect these concepts to AAA architectures existing in fixed networks.

According to the invention, charging and rewarding data, which is generated within the ad hoc network, is transmitted via an access router to a component of an AAA architecture for subsequent forwarding and/or processing purposes. The needed charging data can first be collected by the Secure Incentive-based Charging Protocol (SICP) in the ad hoc network, for example, and then safely be transported to the border of the ad hoc network and then being provided at an access router. From there, the data is transmitted to an AAA architecture in the fixed network, where it can be used extensively by an ISP, for example.

The method according to the invention can be used in different ad hoc networks, but using it in wireless ad hoc networks or in hot spots networks, as for example in airports, hotels or restaurants, seems to be favorable.

Regarding a far-reaching and extensive functionality, it can be provided that the charging and rewarding data is transmitted to an AAA component of a visited network. This is advantageous, as the system access function of authentification in an ad hoc network is always performed over a visited network. Moreover, the charging and rewarding processes of the ISP can be extended to nodes which are temporarily part of the network, but which are not registered in the home network of the access router of the ad hoc network, but in a visited network.

In case that the charging and rewarding processes are supposed to be performed exclusively for nodes which are registered at the home network of the access router of the ad hoc network, the charging and rewarding data can also be transmitted to an AAA component of this home network.

Charging and rewarding data is transmitted in an advantageous way to the AAA server of an AAA architecture administrating the fundamental system access functions of authentification, authorization and use, as well as their billing.

Depending on the respective purpose of use, the different charging and rewarding data can be transmitted to the AAA components. When choosing the transmitted data, the different destinations, which an ISP has for optimization of data storage on his servers, can be taken into consideration. As, in general, the lifetime of the stored data in the access router is significantly shorter than at the AAA components, the ISP has to find a balance which data are to transmit for charging, billing and long term storage. Usually, data in the access router is stored for about a period that corresponds to a period of charging, whereas in Germany this period lasts at least for 82 days regarding the current law situation. In a particularly easy implementation, for example, only the amount of data sent by the nodes to an AAA component themselves can be transmitted as charging and rewarding data for the nodes of the ad hoc network. The amount of sent data can be measured in packets and/or in bytes. Additionally or alternatively, for the nodes, the respective amount of received data—also measured in packets and/or bytes—can be transmitted to a component of the AAA architecture.

Regarding a higher complexity of the method and, in particular regarding the realization of a rewarding concept—in addition to a charging concept—, the respective amount of data forwarded by the nodes can be transmitted to them.

Regarding the calculation of actual costs or rewards, for the nodes, the price relationship between their activities in sending/receiving and forwarding to the AAA architecture could be transmitted. Additionally or alternatively to the price relationship, the absolute costs of the sending and receiving activities and/or the absolute value of the rewarding for forwarding activities could be transmitted.

Regarding an easy allotment of costs and rewards to each node of the ad hoc network respectively, it can be provided that a user-identification is transmitted for the nodes. For each of the nodes, administrative data, in particular identification and/or delegation certificates assigned by a certifying point of the visited domain, could be transmitted. In order to guarantee a high level of security, a symmetric key can be exchanged with the access router of the visited domain.

At this point, it is once more particularly pointed out that depending on the respective purpose and the special objectives of the provider, a different selection of the aforementioned data can be transmitted to the AAA architecture. In case that the ISP needs a “non-repudiation” characteristic for his objectives, all of the aforementioned data must be transmitted as charging and rewarding data. If the main objective is saving long term storage space, then only accumulated data should be transmitted. Such accumulated data can be an invoice final amount after deduction of the reimbursement of actually caused costs.

With respect to a structuring of time of the data transmission, the data for the nodes can be transmitted after each charging period to the AAA architecture, for example. Alternatively, an immediate transmission is supposable, i.e. as soon as the data is available at the access router, it will be transmitted to the AAA components.

In a particularly preferred embodiment the data is transmitted in the format of a RADIUS (remote authentification dial-in user) or diameter protocol. RADIUS is a client-server-based security protocol for authentification and for controlling access authorization. Here, the central administration of user data, such as user ID or access authorization, is supported. The transmission of charging and rewarding data via IPsec or via another security protocol providing end-to-end security can be envisaged. In a closed network, using TCP/UDP packets for transmission of charging and rewarding data to the AAA architecture is also fine.

There are several options how to design and further develop the teaching of the present invention in an advantageous way. For this purpose, it is to be referred to the claims subordinate to the claim 1 on the one hand and to the following explanation of the preferred example of an embodiment of the invention illustrated by the figure on the other hand. In connection with the explanation of the preferred example of an embodiment of the invention according to the figure, preferred embodiments and further developments of the teaching will be explained in general.

### BRIEF DESCRIPTION OF THE DRAWINGS

FIG. 1 is a block diagram shows a scheme of an implementation of a method according to the invention in an ad hoc network and an AAA architecture.

### DESCRIPTION OF THE PREFERRED EMBODIMENTS

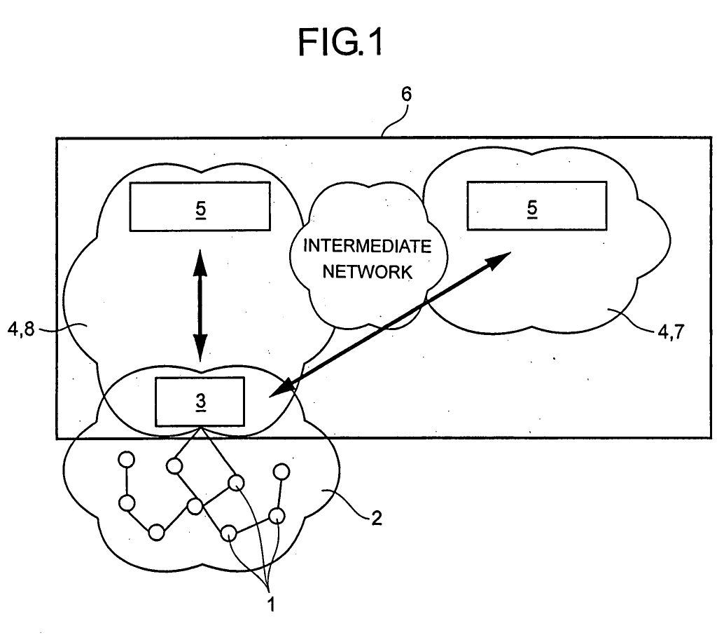

Referring to FIG. 1, a multitude of user nodes 1 interconnecting spontaneously and thus forming an ad hoc network 2 is shown schematically. Within the ad hoc network 2, the nodes 1 act as senders/receivers as well as active intermediate nodes forwarding foreign data.

The charging and rewarding data which was generated depending on their activities in sending/receiving and forwarding respectively, are collected within the ad hoc network 2 by e.g. a Secure Incentive-based Charging Protocol (SICP) and then safely transported to the border of the ad hoc network 2, where they are made available at an access router 3.

According to the invention, the charging and rewarding data are transmitted via the access router 3 to a component of an AAA (authentification, authorization, accounting) architecture 4, where the data can be subsequently processed, for example by an ISP. The transmission as according to the invention is indicated in the figure by the two double arrows. The component to which the data is transmitted is in this special case an AAA server 5.

It is to be annotated that different AAA architectures 4, which are realized within the core network 6, can be used. So, it is for example possible to transmit the charging and rewarding data to the AAA server 5 of the visited network 8 of the access router 3 of the ad hoc network 2. If it is not assured that all the user nodes 1 of the ad hoc networks 2 are registered in the visited network 8 of the access router 3 of the ad hoc network 2, and if the charging and rewarding processes are supposed to be extended to the user node 1 being registered in another network—a home network 7—as well, then the relevant data can also be transmitted to this visited network 8.

Finally, it is particularly pointed out that the described example of an embodiment only serves as an illustration of the claimed teaching, but that it does by no means restrict the latter to the given example of embodiment.

1. A method of performing charging and rewarding processes in ad hoc networks with an ad hoc network showing a multitude of active nodes, the method comprising:
charging a node sending or receiving packets with costs;
rewarding a node forwarding packets within the ad hoc network; and
transmitting charging and rewarding data generated within the ad hoc network, via an access router to a component of an AAA (authentification, authorization, accounting) architecture for subsequent transmission and/or processing purposes.

2. The method according to claim 1, wherein the charging and rewarding data is transmitted to AAA components of a visited network.

3. The method according to claim 1, wherein the charging and rewarding data is transmitted to an AAA component of the home network.

4. The method according to claim 1, wherein the charging and rewarding data is transmitted to an AAA server of an AAA architecture.

5. The method according to claim 1, wherein the amount of data sent by each of the nodes is transmitted as charging and rewarding data.

6. The method according to claim 1, wherein the amount of data received by each of the nodes is transmitted as charging and rewarding data.

7. The method according to claim 1, wherein the amount of data forwarded by each of the nodes is transmitted as charging and rewarding data.

8. The method according to claim 1, wherein for each of the nodes, a ratio between the cost of its sending and receiving activity and the reward for its forwarding activity is transmitted as charging and rewarding data.

9. The method according to claim 1, wherein for each of the nodes, the absolute cost of sending and receiving activity and/or the absolute reward for forwarding activity is transmitted.

10. The method according to claim 1, wherein for each of the nodes, a user id is transmitted.

11. The method according to claim 1, wherein for each of the nodes, administrative data is transmitted.

12. The method according to claim 11, wherein the administrative data includes certificates of identity and/or delegation.

13. The method according to claim 1, wherein for each of the nodes, a symmetric key is transmitted.

14. The method according to claim 1, wherein the data for the nodes is transmitted after each charging period.

15. The method according to claim 1, wherein the data for the nodes is always transmitted as soon as it is available at the access router.

16. The method according to claim 1, wherein the data is transmitted in the format of one of the RADIUS and diameter protocol.

17. The method according to claim 1, wherein the data is transmitted using a security protocol with end-to-end security.

18. The method according to claim 17, wherein the data is transmitted using an IPsec.

19. The method according to claim 1, wherein the data is transmitted using one of TCP and UDP packets.
